(19) United States
(12) Patent Application Publication
(10) Pub. No.: US 2006/0202381 A1
(43) Pub. Date: Sep. 14, 2006

(54) Pipe manufacturing installation and associated defect detection method

(75) Inventors: Christian Bach, Vallamand (CH); Eberhard Kertscher, Yvonand (CH)

Correspondence Address: GRIFFIN & SZIPL, PC, SUITE PH-1, 2300 NINTH STREET, SOUTH, ARLINGTON, VA, 22204, US

(73) Assignee: THE THOMAS MACHINES SA, Couvet (CH)

(21) Appl. No.: 11/370,946

(22) Filed: Mar. 9, 2006

(30) Foreign Application Priority Data
Mar. 10, 2005 (EP) 05005241.4

(51) Int. Cl. B29C 47/92; B29C 47/00; B29C 47/88

(52) U.S. Cl. 264/178 R; 264/211.12; 264/40.6

(57) ABSTRACT

The invention concerns an installation for manufacturing drip irrigation pipes comprising a dripper feed station followed by an extrusion station comprising extrusion means, means for calibrating the pipe and means for welding the drippers to the inner wall of the pipe, and followed by a cooling station for the pipe, of the type wherein the cooling station includes a cooling tank containing a cooling fluid in which the pipe is immersed, characterized in that a detection device is provided for detecting, in the cooling fluid, the emission of gas bubbles through the wall of the pipe, so as to deduce therefrom the presence of perforations and/or cracks. The invention also concerns a method for detecting perforations and/or cracks.

### This application claims priority from European Patent Application No. 05005241.4 filed Mar. 10, 2005, the entire disclosure of which is incorporated herein by reference.

### FIELD OF THE INVENTION

The present invention relates to a drip irrigation pipe manufacturing installation. More specifically, the invention concerns an installation of this type comprising means for checking, in real time, the quality of the manufactured pipes. The invention concerns particularly an installation of this type comprising a cooling tank provided with a device for detecting cracks and perforations, particularly micro-perforations, in the wall of the manufactured pipe.

The invention also concerns a method for detecting cracks and perforations in the wall of a hollow element.

### BACKGROUND OF THE INVENTION

A common technique is to use, for some irrigations, so-called “drip” pipes. These are pipes whose wall is pierced, at pre-determined intervals, with holes of small diameter, through which water flows into the ground. In order to control the flow from the holes with precision, a flow limiter is provided at each hole, commonly called a “dripper”, composed of a part made of hollow plastic material which is bonded to the inner wall of the pipe.

In conventional drip irrigation pipes, the drippers have regularly fed into an extrusion station comprising extrusion, calibration and welding means from a feed device such as a centrifuge bowl and orienter for feeding the drippers along a determined orientation. In the extrusion station, the pipe is continuously produced, calibrated, and the drippers are welded while still warm to the inner wall of the pipe at regular intervals, so that they bond to the latter by melting locally.

After the drippers have been welded to the inner face of the pipe, the pipe is drawn by traction means through a water cooling tank which cools the pipe-dripper assembly, such that the final shape of the pipe is fixed.

After the cooling tank, a perforating station makes a hole in the wall of the pipe, opposite each dripper.

It has been observed that this type of installation can produce pipes whose wall comprises micro-perforation and/or crack type defects. The appearance of micro-perforations and cracks can have several causes. It may be due particularly to the presence of dust in the extrusion station, to the too high grain size of the carbon black present in the pipe material, to dirt in the calibrating means, or to a defect during welding of the drippers.

These defects can generally not be detected by the naked eye, such that pipes can be manufactured and delivered to the client without the defects having been detected, and without the malfunctions responsible for such defects having been remedied. These defects are then revealed, after the pipes have been set in place on the ground, for example in the form of an abnormally high consumption of irrigation liquid.

It is an object of the present invention to overcome the aforementioned drawbacks, in addition to others, by providing a drip irrigation pipe manufacturing installation provided with means for detecting the presence of perforations and/or cracks in the wall of the manufactured drip pipes.

It is also an object of the invention to provide such an installation by implementing simple and inexpensive means.

It is a further object of the invention to provide such an installation comprising means for checking, in real time, the quality of the manufactured pipes and the manufacturing dimensional stability.

### SUMMARY OF THE INVENTION

The present invention therefore proposes, according to a first aspect, a installation for manufacturing a drip irrigation pipe comprising a dripper feed station followed by an extrusion station comprising extrusion means, means for calibrating the pipe and means for welding the drippers to the inner wall of the pipe, and followed by a pipe cooling station, of the type wherein the cooling station comprises a cooling tank containing a cooling fluid in which the pipe is immersed, characterized in that a detection device is provided, which detects, in the cooling fluid, the emission of gas bubbles through the pipe wall, so as to deduce therefrom the presence of perforations and/or cracks in the pipe wall.

Owing to these features, defects in the pipe are detected easily, which enables corrective measures to be taken in the installation to guarantee manufacturing quality.

According to complementary features of the invention, the detection device includes a camera which takes pictures of one area of the cooling fluid, called the analysis area, located at least partly above a section of the pipe and an electronic analysing circuit which determines the presence of gas bubbles from the images taken by the camera. Preferably, the analysis circuit applies a processing algorithm to each picture taken by the camera, comprising at least one step of comparing the image taken by the camera with a reference picture corresponding to the presence of at least one gas bubble.

According to an advantageous feature of the invention, the analysis area is located in proximity to the downstream end of the calibrating means, which enables the appearance of micro-perforations and/or cracks in the pipe wall to be detected early.

According to another advantageous feature of the invention, the cooling tank comprises a portion of transparent wall, called the observation window, and the camera lens is arranged behind the observation window, outside the cooling tank. This particular arrangement facilitates the siting of the camera in the installation, particularly as regards water resistance, and it also means that pictures of sufficient quality are obtained for the electronic analysis circuit to process the images.

According to further advantageous features of the invention, means for cleaning the observation window and means for lighting the cooling tank are provided so as to ensure that the images taken by the camera are of high quality.

Moreover, according to an advantageous embodiment of the invention, the detection device is connected to a warning device and to a central unit so as, for example, to order a spool to be changed when a gas bubble is detected so as to lose the least amount of tube possible.

The present invention also proposes a method for detecting perforations and/or cracks in the wall of a hollow element comprising a peripheral wall and which delimits an inner chamber subject to pressure from a gas such as air, characterized in that it comprises the following successive steps:

an initial step during which the hollow element is immersed in a tank containing a fluid,

an analysis step during which a search is made for the presence of gas bubbles in the tank, and

a detection step during which a warning signal is produced, if at least one gas bubble is detected in the analysis step, so as to indicate the presence of perforations and/or cracks in the wall of the hollow element.

According to a second aspect the invention concerns an installation for manufacturing a drip irrigation pipe comprising a dripper feed station followed by an extrusion station comprising extrusion means, pipe calibrating means and means for welding the drippers to the inner wall of the pipe, and followed by a pipe cooling station, of the type wherein the cooling station comprises a cooling tank containing a cooling fluid in which the pipe is immersed, characterized in that there is provided a detection device comprising a camera which takes pictures of one area of the cooling fluid, called the analysis area, comprising at least one pipe portion and an electronic analysis circuit which detects an alteration in the geometry of the pipe, in relation to a reference geometry, so as to deduce therefrom a problem of manufacturing stability in the pipe from the images taken by the camera.

### BRIEF DESCRIPTION OF THE DRAWINGS

Other features and advantages of the present invention will appear more clearly from the following detailed description of an example embodiment of the installation according to the invention, this example being given solely by way of non-limiting illustration, in conjunction with the annexed drawings, in which:

FIG. 1 is a schematic diagram of an installation for manufacturing drip type irrigation pipes in accordance with the invention;

FIG. 2 is a view along the cross-sectional plane 2-2 which shows schematically the arrangement of the detection device in proximity to the extrusion station of the installation of FIG. 1;

FIG. 3 is a view along the cross-sectional plane 3-3 which shows schematically the detection device of the installation of FIG. 1; and

FIG. 4 is a schematic diagram of a monitoring screen of the camera used in the installation of the invention.

### DETAILED DESCRIPTION OF THE ILLUSTRATIVE EMBODIMENTS

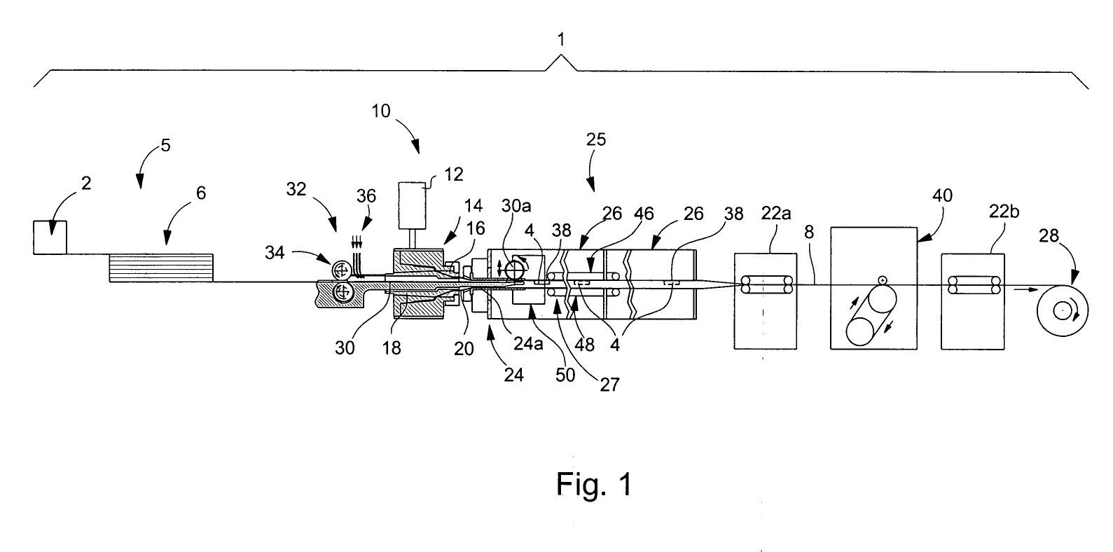

FIG. 1 is a schematic diagram of an installation for manufacturing drip type irrigation pipes. Designated as a whole by the general reference numeral 1, this installation includes in particular a feed station 5 for the drippers 4 which is followed by an extrusion station 10 for pipe 8 and a cooling station 25 for pipe 8.

Feed station 5 includes a magazine 2 such as a centrifugal bowl which sorts, orientates and positions drippers 4 in an accumulator device 6 depending upon the position that they have to have once they are inserted into irrigation pipe 8.

Extrusion station 10 is arranged after accumulator device 6. This extrusion station 10 includes a chamber 12 for melting the plastic material which feeds a unit 14 provided with a die 16 inside which there is provided a guide wire 18 arranged such that a tubular blank 20 comes out of die 16. Blank 20 is drawn by traction stations 22a and 22b passing through calibrating means 24 and a cooling station 25 formed by a cooling tank 26. Beyond traction station 22b, pipe 8 is wound onto a spool 28.

In the following description, an upstream to downstream direction will be used in a non-limiting manner in accordance with the direction in which pipe 8 advances through installation 1.

This arrangement is conventional in plastic pipe manufacturing technology. In order to secure drippers 4, guide wire 18 has an axial passage inside which there is arranged a guide support 30 which extends to the inside of calibrator 24a of calibrating means 24. Guide support 30 receives drippers 4 from magazine 2 via accumulator device 6. A dosing and driving device 32 provided, in the example shown, with air jet 36 assisted feed rollers 34 is provided for moving drippers 4 forward inside calibrator 24a.

In calibrator 24a, the pipe blank 20, whose diameter is calibrated by calibrator 24a, is brought into contact with dripper 4 when its consistency is still pasty using a pressure roller 30a, which thermowelds the top face 38 of dripper 4 against the inner wall of blank 20. On leaving calibrating means 24 and cooling tank 26, pipe 8 enters a perforating station 40 via first traction station 22a, then it leaves the latter to enter the second traction station 22b. In perforating station 40, pipe 8 is perforated with small holes made facing drippers 4 and through which water will flow.

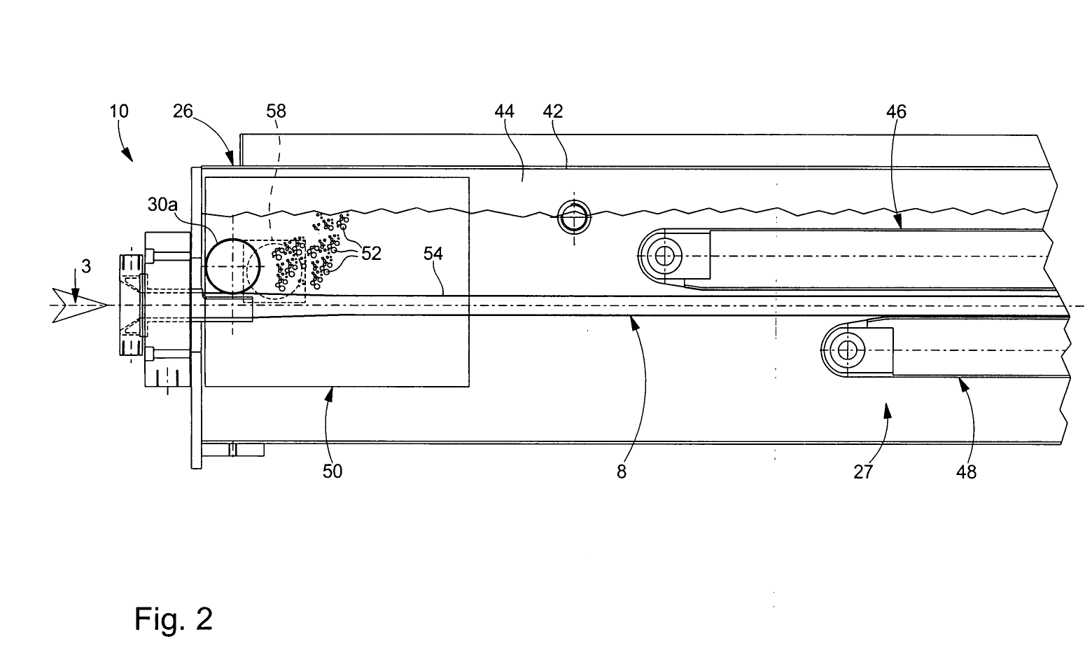

As shown in FIG. 2, cooling tank 26 delimits a hermetic enclosure containing a cooling fluid. The top wall 42 of cooling tank 26 delimits, with the top surface of the cooling fluid, a cavity 44. Aspiration means (not shown) are provided to create a vacuum in cavity 44.

According to the embodiment shown here, a stabilising station 27 is arranged downstream of welding means 30, 30a in vacuum cooling tank 26. In the example shown, stabilising station 27 is immersed in the cooling fluid. Stabilising station 27 includes a top endless belt 46 and a bottom endless belt 48 whose respective bottom and top sides are substantially rectilinear and parallel. These sides are applied against opposite faces of pipe 8 without affecting its dimensional characteristics and while driving and guide pipe 8 without friction.

In accordance with the teaching of the invention, installation 1 is provided with a detection device 50 which detects, in the cooling fluid, the emission of gas subjected to atmospheric pressure, gas bubbles 52 are atmospheric air bubbles.

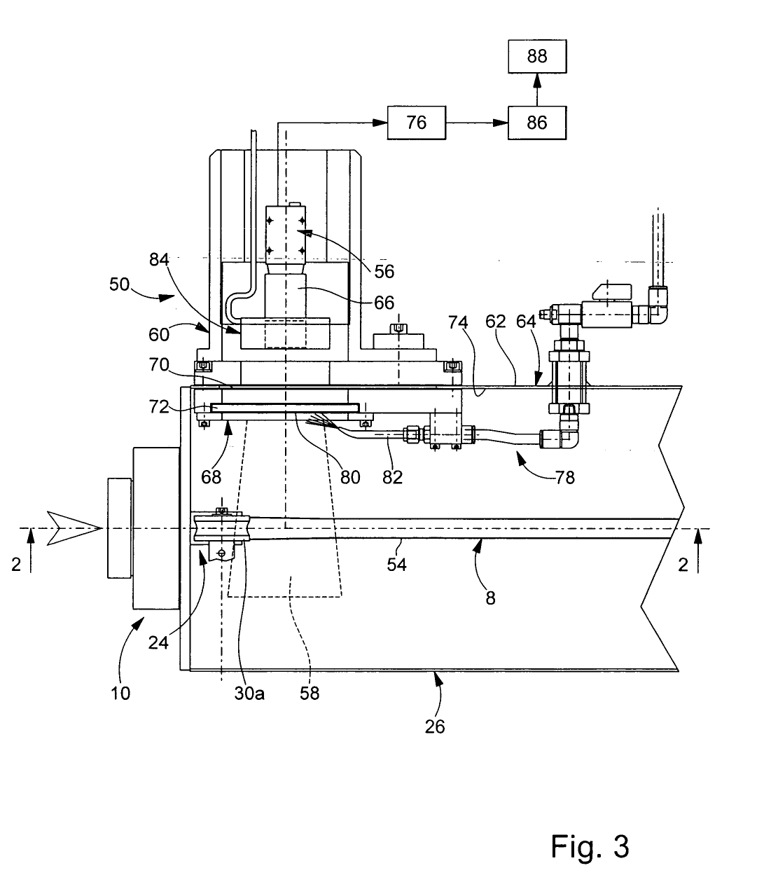

As shown in FIG. 3, detection device 50 includes a camera 56 which takes pictures of an area of the cooling fluid, called analysis area 58, located at least partly above a section of pipe 8. Analysis area 58 is defined overall by the field of vision of camera 56 and by the transparency of the cooling fluid.

Camera 56 is arranged on a support 60 which is fixed to the external face 62 of a lateral wall 64 of cooling tank 26. Said lateral wall 64 includes, opposite lens 66 of camera 56, a transparent portion called observation window 68.

According to the embodiment shown, lateral wall 64 comprises an aperture 70 opposite lens 66 and observation window 68 is formed by a transparent glass 72 which is mounted on the side of inner face 74 of lateral wall 64. Of course, transparent glass 72 is fixed in a water resistant manner, such that the cooling fluid cannot flow through aperture 72 of lateral wall 64.

Detection device 50 comprises an electronic analysis circuit 76 which collects the images taken by camera 56 and which applies, preferably to each picture taken by camera 56, an image processing algorithm for detecting the appearance of air bubbles 52 in the image. Advantageously, this algorithm includes, for each image analysed, at least one step of comparing the imaged being analysed with a reference image corresponding to the presence of at least one bubble 52 in the cooling fluid. Thus, analysis circuit 76 has the image of a bubble 52 stored in its memory, more specifically the image of an air bubble 52 that would appear if there were a micro-perforation and/or micro-crack in the wall 54 of pipe 8. Analysis circuit 76 is thus able to identify, by analogy, the round shape of a bubble 52 in the images taken by camera 56.

According to an alternative embodiment of the invention, the image processing algorithm implemented by analysis circuit 76 can use a reference image corresponding to an absence of any bubbles.

The assembly of camera 56 and electronic analysis circuit 76 is formed by an appropriate vision system like those which are manufactured by Matsushita Electric Works, under the name of “NAIS” or “Panasonic”.

Advantageously, cooling tank 26 is provided with means 78 for cleaning the inner face 80 of transparent glass 72, so as to prevent the deposit of impurities and/or air bubbles on this inner face 80, which could detract from the quality of the images taken by camera 56.

Cleaning means 78 include here a nozzle 82 which is carried by lateral wall 64 of cooling tank 26 and which is oriented towards the inner face 80 of transparent glass 72. Nozzle 82 is connected, through the lateral wall 64, to a pressurised liquid source, so as to produce a flow of liquid which is projected towards transparent glass 72 and which sweeps at least part of transparent glass 72. Nozzle 82 is connected, for example, to the device (not shown) that feeds cooling tank 26 with cooling fluid.

It will be noted that cleaning means 72 are optional.

According to an advantageous embodiment, detection device 50 is fitted with lighting means 84 for the cooling fluid so as to improve the quality of the images taken by camera 56. These lighting means 84 are formed here by an annular light diffusion device which is centred on the axis of lens 66 of camera 56 and which is mounted around said lens 66, outside cooling tank 26.

Detection device 50 controls here a warning device 86 which generates a warning signal when an air bubble 52 is detected. The warning signal is, for example, a light signal and/or an acoustic signal enabling an operator to detect the appearance and the origin of a malfunction of installation 1.

Preferably, detection device 50 is connected to a central unit 88 which, for example, automatically changes the spool 28 when an air bubble 52 is detected.

The operation of detection device 50 according to the invention is as follows.

During the manufacture of pipe 8, camera 56 takes images of analysis area 58. Electronic analysis circuit 76 compares these images with a reference image. In the absence of any perforations and/or cracks in pipe 8, the images taken by camera 56 do not include any bubbles 52.

Since the inside of pipe 8 is subject to the atmospheric pressure of the surrounding air, as soon as a micro-perforation or a micro-crack appears in wall 54 of pipe 8, at least one air bubble 52 escapes from pipe 8 through said micro-perforation or micro-crack, at the moment when pipe 8 enters the cooling fluid. This air bubble 52 then rises to the surface of the cooling fluid.

As soon as an air bubble 52 escapes from pipe 8, it appears in the images taken by camera 56, such that electronic analysis circuit 76 can deduce that at least one micro-perforation or micro-crack is present. Electronic analysis circuit 76 then operates warning device 86 such that it generates a warning signal.

Central unit 88 is informed, here by warning device 86, of the presence of at least one micro-perforation and/or micro-crack, so that it causes spool 28 to be changed.

It will be noted that the detection method implemented by installation 1 according to the invention can be applied to products other than irrigation pipes 8, in particular to any hollow element comprising a peripheral wall 54 which delimits an inner chamber subject to gas pressure, such as atmospheric pressure.

This method includes, in succession, an initial step during which the hollow element 8 is immersed in a tank 26 containing a liquid; an analysis step during which a search is made for the presence of gas bubbles 52 in tank 26; and a detection step during which a warning signal is generated, if at least one air bubble 52 is detected during the analysis step, so as to indicate the presence of perforations and/or cracks in wall 54 of hollow element 8.

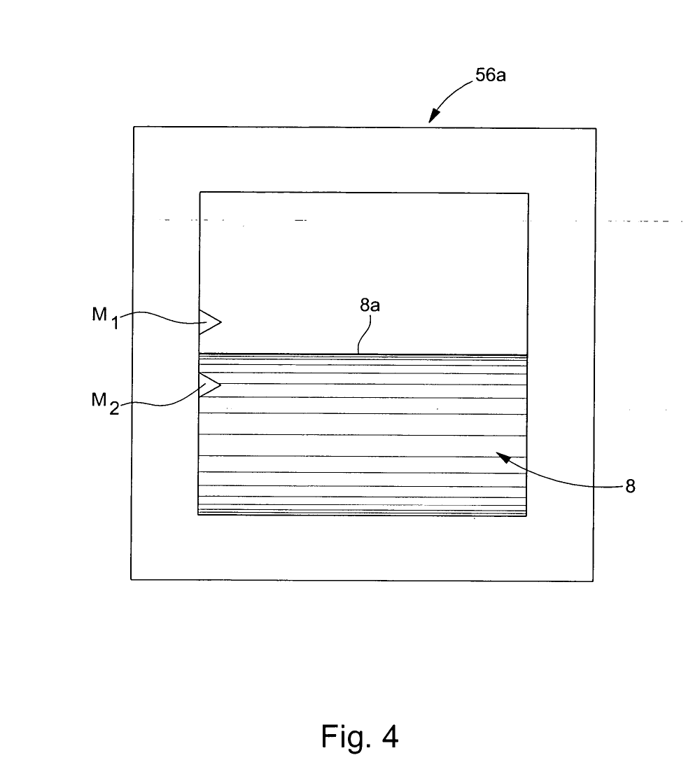

According to an advantageous embodiment, detection device 50 of installation 10 according to the invention is used for detecting an alteration in the geometry of pipe 8, in relation to a reference geometry. An “alteration in geometry” means an alteration in the shape and/or dimension of the pipe, for example an increase or decrease in its diameter. For this purpose, the images taken by camera 56 cover at least a portion of pipe 8, and analysis circuit 76 applies, to each image taken by camera 56, an image processing algorithm comprising at least either a step of comparing the image taken by camera 56 with a reference image corresponding to a reference geometry of pipe 8, or a step of determining the position of the external surface 8a of pipe 8 in relation to one or several markers M1, M2 of camera 56 as can be seen in FIG. 4, which shows schematically a monitoring screen 56a of the camera.

This embodiment enables detection device 50 to be used for detecting problems of stability, or malfunctions, in the manufacturing process of pipe 8, which result, for example, in a decrease in the external diameter of pipe 8. It thus improves the reliability of installation 1 and the quality of the manufactured pipe 8.

Of course, detection device 50 could be dedicated to the detection of an alteration in the geometry of pipe 8, without bothering about the detection of gas bubbles. Installation 1 according to the invention could also include a first detection device 50 dedicated to the detection of gas bubbles 52 and a second detection device dedicated to detection of an alteration in the geometry of pipe 8.

It goes without saying that the present invention is not limited to the embodiment which has just been described and that various simple alterations and variants can be envisaged by those skilled in the art without departing from the scope of the invention as defined by the annexed claims. In particular, instead of a vacuum cooling tank, a cooling tank under atmospheric pressure could be used. A gas would be injected into the tube being formed, for example from the back of the extrusion head so that the tube keeps it shape before it has cooled.

1. An installation for manufacturing a drip irrigation pipe including:
a dripper feed station followed by an extrusion station including extrusion means;
means for calibrating pipe; and
means for welding drippers to the inner wall of a pipe, and followed by a cooling station for the pipe, wherein the cooling station includes a cooling tank containing a cooling fluid in which the pipe is immersed, wherein a detection device is provided for detecting, in the cooling fluid, the emission of gas bubbles through the wall of the pipe, so as to deduce therefrom the presence of perforations or cracks or perforations and cracks in the wall of the pipe.

2. The installation according to claim 1, wherein the detection device includes a camera which takes images of one area of the cooling fluid, called the analysis area, located at least partly above a section of the pipe and an electronic analysis circuit that determines the presence of gas bubbles from the images taken by the camera.

3. The installation according to claim 2, wherein the electronic analysis circuit applies, to each image taken by the camera, an image processing algorithm including at least one step of comparing the image taken by the camera with a reference image corresponding to the presence of at least one gas bubble.

4. The installation according to claim 2, wherein the analysis area is located in proximity to the downstream end of the calibrating means, relative to the direction in which the pipe advances in the cooling fluid.

5. The installation according to claim 2, wherein the cooling tank includes a transparent wall portion that is an observation window, and wherein the lens of the camera is arranged behind the observation window, outside the cooling tank.

6. The installation according to claim 5, wherein the cooling tank includes means for cleaning the inner face of the observation window.

7. The installation according to claim 6, wherein the cleaning means include at least one nozzle that projects a flow of liquid onto the inner face of the observation window.

8. The installation according to claim 2, wherein the detection device is fitted with means for lighting the cooling fluid so as to improve the quality of the images taken by the camera.

9. The installation according to claim 8, wherein the lighting means include an overall annular light diffusion device that is arranged around the lens of the camera.

10. The installation according to claim 1, wherein the detection device operates a warning device that generates a warning signal when an air bubble is detected.

11. The installation according to claim 1, wherein the detection device is connected to a central unit that orders a change of spool when an air bubble is detected.

12. An installation for manufacturing a drip irrigation pipe including:
a dripper feed station followed by an extrusion station including extrusion means;
means for calibrating pipe; and
means for welding drippers to the inner wall of the pipe, and followed by a cooling station for the pipe, wherein the cooling station includes a cooling tank containing a cooling fluid in which the pipe is immersed, wherein there is provided a detection device including a camera that takes images of an area of the cooling fluid that is an the analysis area, including at least one portion of pipe and an electronic analysis circuit that detects an alteration in the geometry of the pipe, in relation to a reference geometry, so as to deduce a problem in manufacturing stability of the pipe from images taken by the camera.

13. The installation according to claim 12, wherein the electronic analysis circuit applies, to each image taken by the camera, an image processing algorithm including at least one step of comparing the image taken by the camera with a reference image corresponding to a reference geometry of the pipe.

14. The installation according to claim 12, wherein a single detection device is provided that detects the emission of gas bubbles and an alteration in the geometry of the pipe.

15. The installation according to claim 12, wherein there is provided a first detection device that detects the emission of gas bubbles and a second detection device that detects an alteration in the geometry of the pipe.

16. A method for detecting perforations or cracks or perforations and cracks in the wall of a hollow element including a peripheral wall that delimits an inner chamber subject to a gas pressure such as atmospheric pressure, wherein the method includes the following successive steps:
an initial step during which a hollow element is immersed in a tank containing a fluid;
an analysis step during which a search is made for presence of gas bubbles in the tank; and
a detection step during which a warning signal is produced, if at least one gas bubble is detected in the analysis step, so as to indicate the presence of perforations or cracks or perforations and cracks in the wall of the hollow element.

17. The method according to claim 16, wherein the analysis step includes a phase of analysing the images of one area of fluid located at least partially above the hollow element.

18. The method according to claim 17, wherein the image analysis phase includes a step of comparing an image of the fluid area with a reference image corresponding to an absence of gas bubbles.

19. The method according claim 16, wherein the hollow element is a pipe.
